(19) United States
(12) Patent Application Publication
(10) Pub. No.: US 2025/0323677 A1
(43) Pub. Date: Oct. 16, 2025

(54) Hybrid PHY for flexible choice of operating modes

(71) Applicant: Marvell Asia Pte Ltd, Singapore (SG)

(72) Inventors: Whay Sing Lee, Milpitas, CA (US); Arash Farhoodfar, Milpitas, CA (US); Xi Wang, Saratoga, CA (US); Lenin Kumar Patra, Dublin, CA (US); Stephen Jantzi, Laguna Beach, CA (US); Cindra Abidin, Irvine, CA (US); Shawn Scouten, Ottawa (CA); Jamal Riani, Best (NL)

(21) Appl. No.: 19/173,853

(22) Filed: Apr. 9, 2025

Related U.S. Application Data
(60) Provisional application No. 63/632,475, filed on Apr. 10, 2024.

(51) Int. Cl. H04B 1/401

(52) U.S. Cl. CPC H04B 1/401

(57) ABSTRACT

A Physical Layer (PHY) device includes an ingress transceiver, an egress transceiver and a controller. The ingress transceiver and the egress transceiver each includes respective analog signal processing (ASP) circuitry and respective digital signal processing (DSP) circuitry. The controller is configured to select an operational mode, for one or both of the ingress transceiver and the egress transceiver, between (i) a digital mode in which both the ASP circuitry and the DSP circuitry are active, and (ii) an analog mode in which the ASP circuitry is active and the DSP circuitry is bypassed.

### CROSS-REFERENCE TO RELATED APPLICATIONS

This application claims the benefit of U.S. Provisional Patent Application 63/632,475, filed Apr. 10, 2024, whose disclosure is incorporated herein by reference.

### FIELD OF THE DISCLOSURE

The present disclosure relates generally to communication systems, and more particularly to transceiver systems with flexible operating modes.

### BACKGROUND

Physical layer (PHY) devices, representing the lowest layer of the OSI 7-layer model, are integral components in modern communication systems. These devices facilitate the transmission and reception of data across various network interfaces by converting digital signals into formats suitable for transmission over physical media, such as optical fibers or copper cables, and vice versa. The PHY layer should be carefully designed to overcome media noise and adapt to varying channel conditions, ensuring reliable data transfer between network nodes. By addressing challenges such as latency, signal attenuation, interference, and distortion, well-engineered PHY transceivers can significantly enhance the overall performance and reliability of communication across diverse operating environments.

The description above is presented as a general overview of related art in this field and should not be construed as an admission that any of the information it contains constitutes prior art against the present patent application.

### SUMMARY

An embodiment that is described herein provides a Physical Layer (PHY) device including an ingress transceiver, an egress transceiver and a controller. The ingress transceiver and the egress transceiver each includes respective analog signal processing (ASP) circuitry and respective digital signal processing (DSP) circuitry. The controller is configured to select an operational mode, for one or both of the ingress transceiver and the egress transceiver, between (i) a digital mode in which both the ASP circuitry and the DSP circuitry are active, and (ii) an analog mode in which the ASP circuitry is active and the DSP circuitry is bypassed.

In some embodiments, the controller is configured to select the operational mode independently for the ingress transceiver and for the egress transceiver. In an embodiment, the ASP circuitry includes analog repeater circuitry configured to amplify an analog signal. In an embodiment, the DSP circuitry includes digital retiming circuitry configured to digitally adjust a sampling timing of a digital signal.

In a disclosed embodiment, the DSP circuitry has a first latency, and the ASP circuitry has a second latency smaller than the first latency. In an example embodiment, when either or both of the ingress transceiver and the egress transceiver operate in the analog mode, the DSP circuitry is bypassed but active and is configured when bypassed to collect telemetry information.

In an embodiment, the ingress transceiver and the egress transceiver are configured to, respectively, receive and transmit signals over a communication link; and the controller is configured to select the operational mode by comparing channel conditions of the communication link to a defined level.

There is additionally provided, in accordance with an embodiment that is described herein, a network device including multiple Physical Layer (PHY) devices and a controller. The multiple PHY devices are configured to communicate over respective network links. The PHY devices include ingress transceivers and egress transceivers, each of the ingress transceivers and egress transceivers including respective analog signal processing (ASP) circuitry and respective digital signal processing (DSP) circuitry. The controller is configured to select an operational mode for one or both of the ingress transceivers and the egress transceivers of each PHY device, the operational mode selected between (i) a digital mode in which both the ASP circuitry and the DSP circuitry are active, and (ii) an analog mode in which the ASP circuitry is active and the DSP circuitry is bypassed.

In some embodiments, the controller is configured to select the operational mode for first and second PHY devices independently of one another.

There is additionally provided, in accordance with an embodiment that is described herein, a method in a Physical Layer (PHY) device that includes an ingress transceiver and an egress transceiver, each including respective analog signal processing (ASP) circuitry and respective digital signal processing (DSP) circuitry. The method includes selecting an operational mode, for one or both of the ingress transceiver and the egress transceiver, between (i) a digital mode in which both the ASP circuitry and the DSP circuitry are active, and (ii) an analog mode in which the ASP circuitry is active and the DSP circuitry is bypassed. Communication is performed over a communication link in accordance with the selected operational mode.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a single-channel Hybrid PHY device, in accordance with an embodiment that is disclosed herein;

FIG. 2 is a block diagram that schematically illustrates a network device comprising multiple Dual Mode Hybrid PHY devices, in accordance with an embodiment that is disclosed herein;

FIG. 3 is a block diagram that schematically illustrates a Hybrid PHY device, in accordance with an embodiment that is disclosed herein;

FIG. 4A is a block diagram that schematically illustrates a HDSP-LDSP-mode Hybrid PHY Device that is coupled to an optical link (“line”), in accordance with an embodiment that is described herein;

FIG. 4B is a block diagram that schematically illustrates a HDSP-LANALOG-mode Hybrid PHY Device that is coupled to an optical link, in accordance with an embodiment that is described herein;

FIG. 4C is a block diagram that schematically illustrates a HANALOG-LDSP-mode Hybrid PHY Device that is coupled to an optical link, in accordance with an embodiment that is described herein;

FIG. 4D is a block diagram that schematically illustrates a HANALOG-LANALOG-mode Hybrid PHY Device that is coupled to an optical link, in accordance with an embodiment that is described herein;

FIG. 5 is a block diagram that schematically illustrates a Hybrid PHY device that is configured to provide both rich telemetry information and low latency, in accordance with an embodiment that is disclosed herein;

FIGS. 6-8 are block diagrams that schematically illustrate physical layouts of optical communication systems, in accordance with embodiments that are disclosed herein; and

FIG. 9 is a flowchart that schematically illustrates a method for configuring a Hybrid transceiver, in accordance with an embodiment that is disclosed herein.

### DETAILED DESCRIPTION OF EMBODIMENTS

Two main types of PHY devices can be used to address different application requirements and operating conditions. The first type comprises a low-cost, low-latency “eye opener” that primarily relies on analog circuits to repeat signals over physical distances. These devices are useful in applications where minimal signal processing and low latency are desired.

The second type comprises a feature-rich, high-performance “DSP retimer” that utilizes digital signal processing (DSP) technology to retime signals while covering physical distances. These devices offer advanced capabilities, including enhanced signal conditioning.

Each of the two types of PHY transceivers exhibits distinct properties in terms of performance, latency, and feature set. System designers may select a specific type of anticipated application requirements and operating conditions.

This approach, however, can lead to challenges when the actual deployment environment differs from the initial expectations or when requirements change over time. Moreover, in some cases, different properties may be desired for the receive and transmit directions, or among different receive or transmit channels. This variability in requirements adds further complexity to the selection and deployment of PHY devices.

Embodiments that are described herein provide PHY devices that incorporate both analog and DSP technologies into the same device. The operating mode may be selectively configured at deployment time and/or at any time after the device has been put into service, to achieve a desirable mix of properties according to potentially changing application requirements and operating conditions.

In some embodiments, a disclosed Hybrid Physical Layer (PHY) device supports multiple operating modes, including an analog “eye-opener” mode and a digital “DSP retimer” mode (for shorter terminology, the analog eye-opener mode and the DSP retimer mode will be sometimes referred to as analog mode and DSP mode, respectively). The Hybrid PHY architecture described herein provides flexibility to adapt to various deployment conditions and application requirements, offering advantages in system design and performance optimization.

In some embodiments, the Hybrid PHY device incorporates both analog and digital signal processing circuitry, allowing for selective activation or bypassing of certain components based on the chosen operating mode. This configurability enables the device to achieve different performance characteristics, such as latency, power consumption, and signal processing capabilities, depending on specific application needs or operating environments.

The following detailed description presents various embodiments and implementations of the hybrid PHY device system, including its components, operating modes, and methods for mode selection and configuration. The disclosure also describes telemetry and diagnostic features that may enhance the functionality of the PHY device.

In some embodiments described hereinbelow, the Hybrid PHY device comprises a first PHY transceiver that receives an input signal from a host ASIC and sends an output signal, e.g., through a laser, to an optical network; and a second PHY transceiver that receives an input signal from the optical network (e.g., through a photodetector) and sends an output signal to the host ASIC. We will refer to the first PHY transceiver as an Egress Transceiver and to the second PHY transceiver as an Ingress Transceiver (the directions implied by the Ingress and Egress terms apply to the line connection).

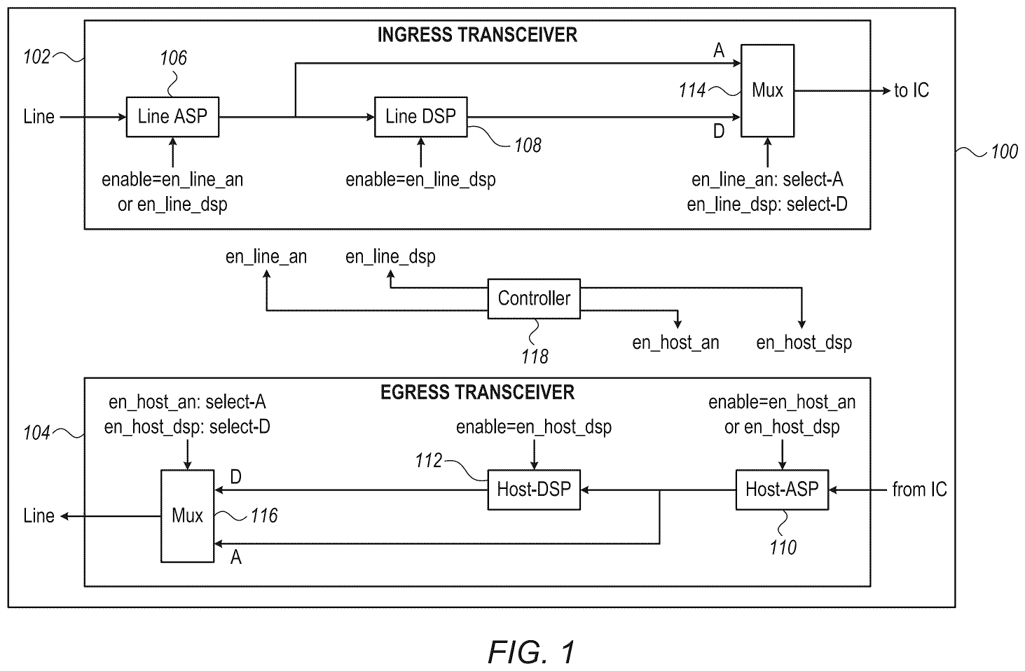

FIG. 1 is a block diagram that schematically illustrates a single-channel Hybrid PHY device 100, in accordance with an embodiment that is disclosed herein.

The Hybrid PHY device 100 comprises an Ingress Transceiver 102 and an Egress Transceiver 104. Ingress Transceiver 102 receives signals from a communication channel (“Line”), e.g., an optical link, processes the received signals and outputs the processed signals to an IC. Egress Transceiver 104 receives signals from the IC, processes the received signals and outputs the processed signals to the communication link.

The Ingress Transceiver 102 comprises a Line Analog Signal Processor (Line-ASP) 106 and a Line Digital Signal Processor (Line-DSP) 108. The Egress Transceiver 104 comprises a Host Analog Signal Processor (Host-ASP) 110 and a Host Digital Signal Processor (Host-DSP) 112.

An Ingress Multiplexor 114 is configured to select between the outputs of the Line-ASP 106 and the Line-DSP 108. Similarly, an Egress Multiplexor 116 is configured to select between the outputs of the Host-ASP 112 and the Host-DSP 114. A PHY controller 118 is coupled to the Ingress Multiplexor 114 and the Egress Multiplexor 116 to control the selection of operating modes.

The analog signal processing components, including the Line-ASP 106 and the Host-ASP 112 typically include various analog circuits for signal amplification and conditioning, and may be designed to provide low-latency signal processing.

The digital signal processing components, including the Line-DSP 108 and the Host-DSP 112, offer more advanced signal processing capabilities and may include digital signal processing functions such as error correction, equalization, coding/decoding etc., including algorithms for signal enhancement and data manipulation and for sampling retiming. The digital processing enhances the channel signal quality and re-times the sampling of the channel, to minimize sampling errors.

The PHY controller 118 manages the operation of the PHY device 100 by configuring the Ingress Multiplexor 114 and the Egress Multiplexor 116. The configuration may allow the PHY device 100 to switch between an analog eye-opener mode (or Analog Mode), where signals primarily pass through the analog components, and a DSP retimer mode (or DSP Mode), where signals undergo analog as well as digital processing. The PHY controller 118 may select the configurations of the Ingress Transceiver 102 and/or the Egress Transceiver 104 based on various factors such as latency requirements, signal quality, power requirements, or specific application needs. In some embodiments, some of the configurations may be hardwired, selected during reset, selected by firmware, selected by an operator, and/or selected according to signal quality measurements.

In some embodiments, signal quality lor, equivalently, channel conditions) can be measured or estimated by Ingress Transceiver 102, by Egress Transceiver 104 and/or by controller 118.

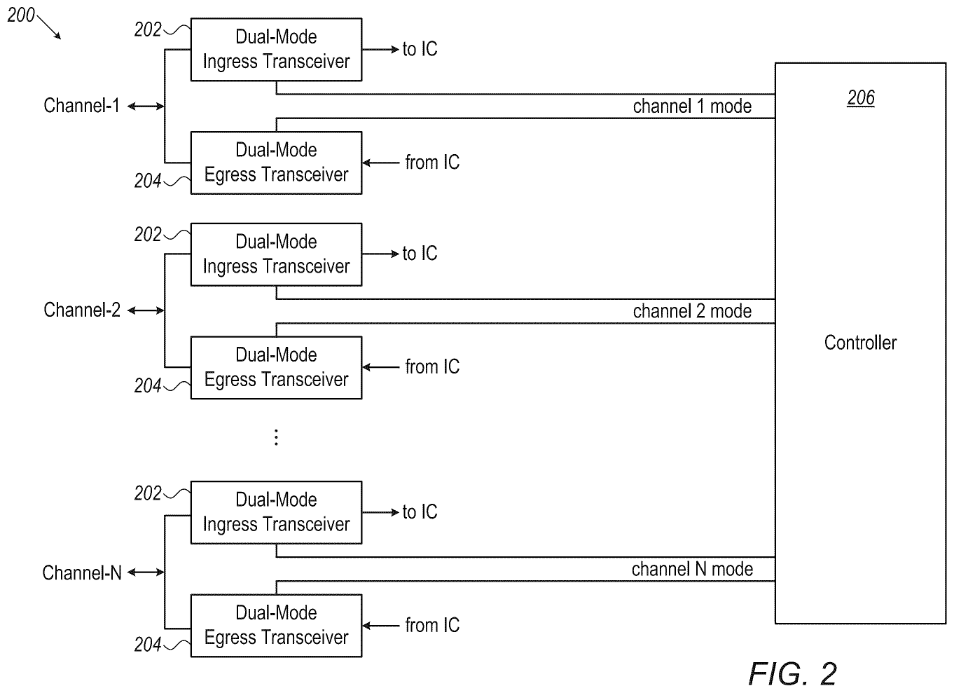

FIG. 2 is a block diagram that schematically illustrates a Dual-Mode Hybrid PHY device 200, in accordance with an embodiment that is disclosed herein. The Dual-Mode Hybrid PHY 200 comprises a plurality of channels, each channel comprising a dual mode Ingress Transceiver 202 and a dual mode Egress Transceiver 204 (in some embodiments, one or all of the Ingress and/or Egress transceivers may comprise single mode transceivers). Each channel is configured to communicate over a respective communication link, e.g., an optical link.

In embodiments, the dual-mode Ingress Transceiver 202 is configured to process incoming channel signals in either the analog mode or the DSP mode (as defined above). Similarly, the dual-mode Egress Transceiver 204 is configured to process incoming host signals in the analog mode or in the DSP mode (in some cases, combined modes of operations may be used, where some of the digital circuits are active. This will be described below, with reference to FIG. 5).

The Hybrid PHY 200 also includes a Controller 206, which is coupled to each channel's dual mode Ingress Transceiver 202 and dual mode Egress Transceiver 204. In some embodiments, the Controller 206 is configured to manage the operating modes of the Ingress and the Egress transceivers independently for each channel. This architecture allows the Dual-Mode Hybrid PHY device 200 to adapt its signal processing capabilities on a per-channel basis, potentially optimizing performance for varying channel conditions or application requirements.

For example, in some embodiments, controller 206 may choose the operating mode for a given channel based on the specific channel conditions (or, equivalently, signal quality) on that channel. The signal quality or channel conditions can be measured or estimated by the corresponding ingress transceiver 202, by the corresponding egress transceiver 204, and/or by controller 206.

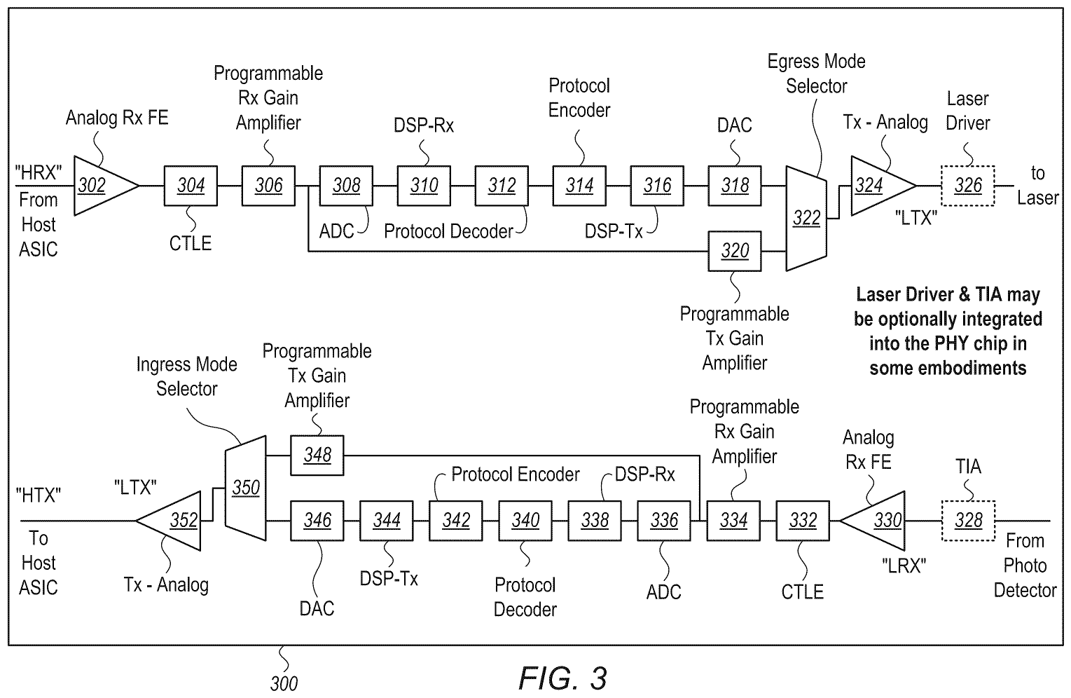

FIG. 3 is a block diagram that schematically illustrates a Hybrid PHY device 300, in accordance with an embodiment that is disclosed herein. In the example embodiment illustrated in FIG. 3, the Hybrid PHY device relays information between a Host ASIC (also referred to as Host hereinbelow) and a communication link, in the present example an optical channel. Communication between the Host and the Hybrid PHY device, in both directions, is done in the analog domain, wherein internal processing within the transceivers may be done in the digital and/or the analog domain. The communication between the Transceivers and the optical channel, through a laser that converts an analog signal into light for driving the optical channel, and through a photo detector that converts light into an analog signal for receiving signal from the optical channel, is also done in the analog domain.

We will use the following terms for the two paths (the “Host” below refers to a HOST-ASIC):

HRX-LTX (Host-Rx, Line-Tx)—an Egress transceiver, receives data from the host and transmits data to the optics;

LRX-HTX (Line-Rx, Host-Tx)—an Ingress transceiver, receives data from the optics and transmits data to the host.

In both cases, DSP and Analog refer to operation modes of the receive paths-Host-Rx and Line-Rx.

The HRX-LTX path of Hybrid PHY device 300 comprises, in embodiment, an Analog-Front-End an Amplifier 302 to amplify the input signal, a Continuous-Time Linear Equalizer 304 to compensate for channel distortions and to equalize the frequency response of the received signal, a Programmable-Gain Amplifier 306 to adjust the signal amplitude, an Analog-to-Digital Converter (ADC) 308 to convert the signal to a digital representation, an Rx-DSP 310 to perform advanced signal processing operations and to retime data sampling (for improved channel performance), a Protocol Decoder 312 to decode the input data and a Protocol Encoder 314 to encode the output data according to specific protocols.

In embodiments, the HRX-LTX path further comprises a DSP-Tx 316 to apply digital processing to the output signal, a Digital-to-Analog Converter (DAC) 318 to convert digital signals back to analog format, a Programmable-Gain Amplifier (PGA) 320 to adjust the gain of the analog transmit path, an Egress Mode Selector 322 to select between the DAC 318 while in the DSP mode and the PGA 320 while in the analog mode, an Analog Transmitter 324, and a Laser-Driver 326.

The LRX-HTX path of Hybrid PHY device 300 comprises a Trans-Impedance Amplifier (TIA) 328 to amplify the signal from a Photo-Detector, an Analog-Front-End Amplifier 330 to amplify the analog input signal, a Linear Equalizer 332 to compensate for channel distortions, a PGA 334 to improve dynamic range utilization, an ADC 336 to convert the LRX-HTX stream to digital, a DSP-Rx 338 to perform additional signal processing operations and to retime data sampling (for improved channel performance), a Protocol Decoder 340 to decode the input stream received from the optics and a Protocol Encoder 342 to encode symbols for transmission to the Host.

In embodiments, the LRX-HTX path further comprises a Tx-DSP 344 to perform additional transmit signal processing operations, a DAC 346 to convert the transmit signal to analog, a PGA 348 to adjust a transmit power level, an Analog Multiplexor 350 to select between the DAC 346 while in the DSP mode and the PGA 348 while in the analog mode, and an Analog Transmitter 352 to send the analog signal to the Host-ASIC.

It should be noted that although some circuits of the HRX-LTX path and the LRX-HTX paths have the same name and carry out the same or similar functionalities, the actual implementations may vary according to the required functionality. Thus, for example, ADC 336 and ADC 308 may have different resolutions; PGA 306 and PGA 348 may have different specifications, etc.

The following table shows which units are active in each mode, for the HRX-LTX and the LRX-HTX paths:

| | HRX-LTX path | LRX-HTX path |
|---|---|---|
| Analog Mode | 302, 304, 306, 320, | 328, 330, 332, 334, |
| | 322, 324, 326 | 348, 350, 352 |
| DSP Mode | All except 320 | All except 348 |

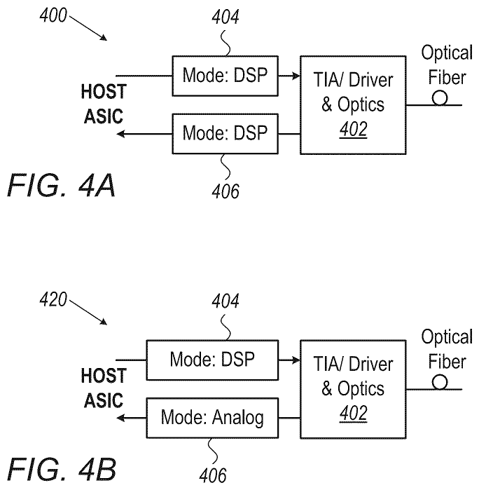

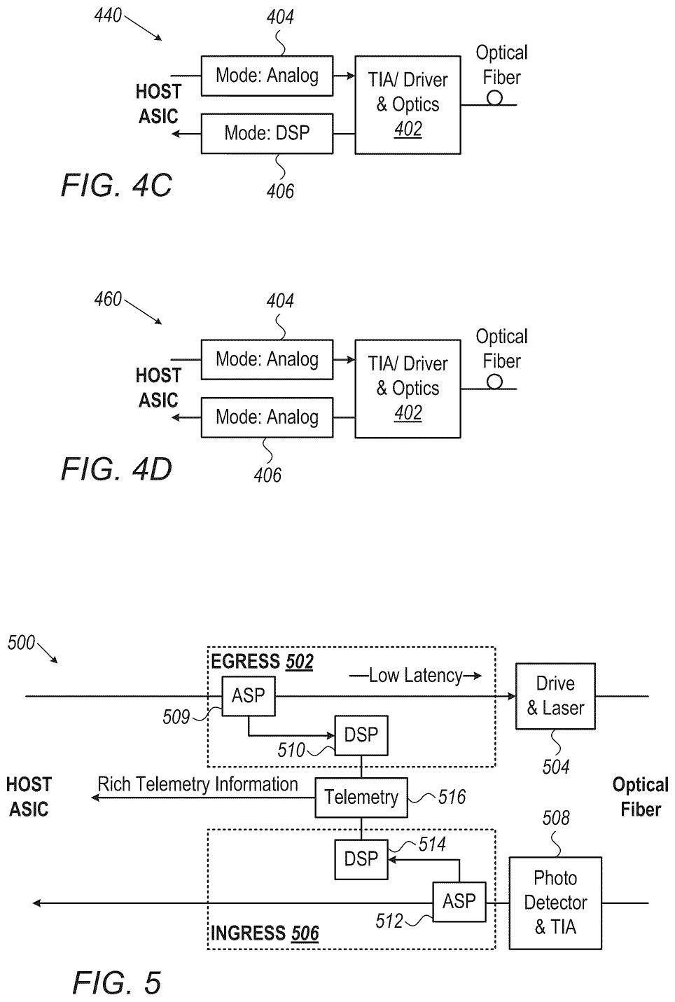

FIG. 4A is a block diagram that schematically illustrates a HDSP-LDSP-mode Hybrid PHY device 400 that is coupled to an optical link (“line”), in accordance with an embodiment that is described herein. The Hybrid PHY device transfers data between the Host and, through a TIA Driver & Optics 402, the optical link. The term HDSP-LDSP implies DSP-mode receivers for both the host input (Egress) and the line input.

PHY device 400 comprises an Egress Transceiver 404 to receive an input signal from the Host, process the input signal and send an output signal to the TIA Driver & Optics 402, which will send a corresponding light signal over the optical link, and an Ingress Transceiver 406 to receive an input signal from the TIA Driver & Optics 402, process the input signal and send a corresponding output signal to the Host. According to the example embodiment illustrated in FIG. 4A, both Egress Transceiver 404 and Ingress Transceiver 406 are configured to the DSP mode. This configuration may be useful when advanced signal processing is required for both directions.

FIG. 4B is a block diagram that schematically illustrates a HDSP-LANALOG-mode Hybrid PHY device 420 that is coupled to an optical link, in accordance with an embodiment that is described herein. PHY device 420 is like PHY device 400 (FIG. 4A), except that Egress Transceiver 404 is configured to the DSP mode and Ingress Transceiver 406 is configured to the Analog mode. This configuration may be useful, for example, when advanced signal processing is required to process the input data from the Host, but, in the path from the optical link, low-latency reception is prioritized.

FIG. 4C is a block diagram that schematically illustrates a HANALOG-LDSP-mode Hybrid PHY device 440 that is coupled to an optical link, in accordance with an embodiment that is described herein. PHY device 440 is like PHY device 400 (FIG. 4A), except that Egress Transceiver 404 is configured to the Analog mode and Ingress Transceiver 406 is configured to the DSP mode. This mode may be beneficial, for example, in situations where complex signal processing is needed for the signal received from the optical link but is not needed for the receipt of the Host signal.

FIG. 4D is a block diagram that schematically illustrates a HANALOG-LANALOG-mode Hybrid PHY device 460 that is coupled to an optical link, in accordance with an embodiment that is described herein. PHY device 460 is like PHY device 400 (FIG. 4A), except that both Egress Transceiver 404 and Ingress Transceiver 406 are configured to the Analog mode. This configuration provides the lowest latency in both directions.

In some embodiments, the receivers of the hybrid PHY device may be configured to a Mixed Mode, in which the output of the ASP is directly routed to the Transmit circuit, and, yet some or all the DSP circuitry is active. This may be useful, for example, in Telemetry applications, wherein the Hybrid PHY device, in addition to handling communication functions, also provides channel telemetry information.

FIG. 5 is a block diagram that schematically illustrates a Hybrid PHY device 500 that is configured to provide both rich telemetry information and low latency, in accordance with an embodiment that is disclosed herein. In the Host-to-Optics path, the Hybrid PHY device 500 comprises an Egress Transceiver 502 that processes an input signal that the Host outputs, and sends an output signal, through a Drive & Laser circuit 504, to an Optical Fiber. In the Optics-to-Host path, the Hybrid PHY device comprises an Ingress Transceiver 506 that processes an input signal that a Photo-Detector & TIA circuit 508 outputs and sends an output signal to the host.

The Egress Transceiver 502 comprises an ASP 509 and a DSP 510; similarly, The Ingress Transceiver 506 comprises an ASP 512 and a DSP 514.

According to the example embodiment illustrated in FIG. 5, Hybrid PHY device 500 is required to exhibit low signal latencies, in both the Host to Optical-Fiber and Optical-Fiber to host directions; however, the Hybrid PHY device 500 is also required to provide channel telemetry information pertaining to both the Optical Fiber and the Host interface signal. Towards that end, in an embodiment, both Egress Transceiver 502 and Ingress Transceiver 506 are configured to a mixed mode, in which both ASPs 509, 512 and DSPs 510, 514 are active. Low latency is obtained by forwarding the outputs of ASPs 509, 512 to the Host and to the Photo-Detector&TIA circuit 508 (respectively). Telemetry is provided by using part of the DSP circuits 510, 514 to collect host-interface and optical-Fiber channel telemetry information (e.g., voltage levels, spectrum, etc.) and sending the channel information, through a Telemetry circuit 516, to the Host. In some embodiments the Telemetry circuit 516 sends the channel telemetry information multiplexed with the fiber optics ingress data, using the same wires; in other embodiments, the Telemetry circuit 516 sends the channel telemetry information on a sideband channel.

The ability to flexibly configure different operating modes and a mix of features yields (but is not limited to) the following benefits and advantages:
1. The designer is not forced to make a-priori tradeoffs at part selection time, when having only imperfect knowledge of the eventual application requirements of the end-product.
2. The system can adapt to different operating conditions, even if such conditions change over the lifetime of the product.
3. The system vendor needs only to stock a single Stock Keeping Unit (SKU, or Part Number) for a variety of application needs, thereby simplifying inventory management.
4. Aside from a steady-state mission mode that is optimized to the application and operating conditions, the PHY device may also be temporarily reconfigured in other modes for debug and diagnostics purposes.
5. The PHY device may be configured to deliver certain mixes of properties (e.g., low latency and rich telemetry), which may be desirable to the end user.

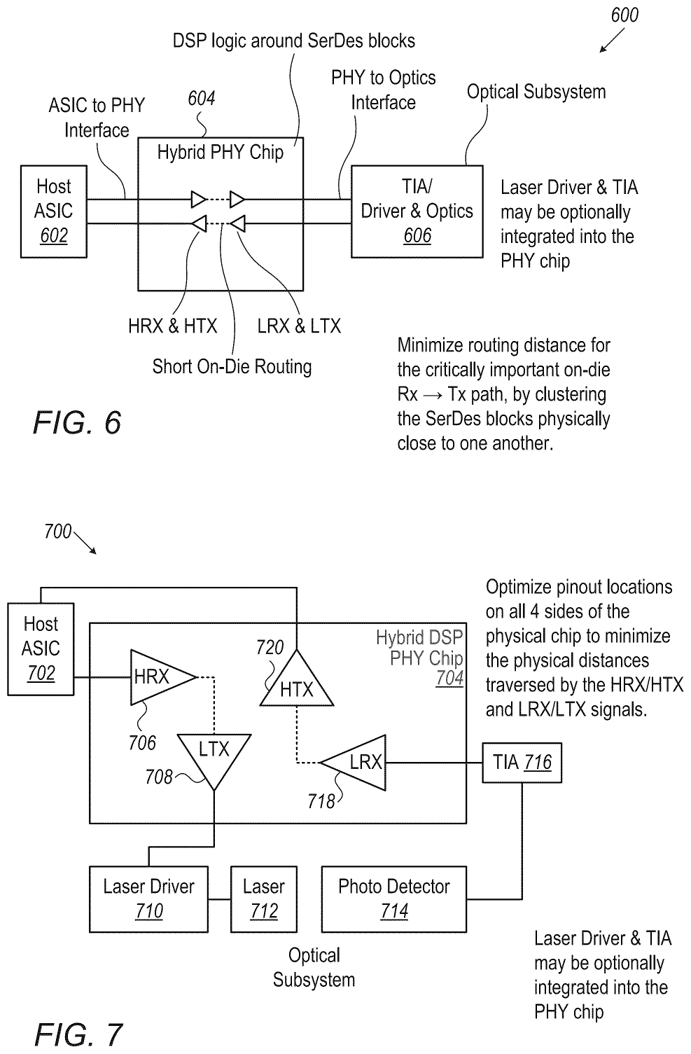

With reference to FIGS. 6 through 8, three example embodiments of Hybrid PHY ICs (also referred to as Chips), in three optical communications systems are described. The Receive circuits of the Hybrid-PHY chips in the example embodiments described below can be configured to be in the Analog or the DSP modes (or in a mixed mode, as described above)

FIG. 6 is a block diagram that schematically illustrates the physical layout of an optical communication system 600, in accordance with an embodiment that is disclosed herein. A Host-ASIC 602 sends and receives electrical information, through a Hybrid-PHY Chip 604, to/from an Optical Subsystem 606 (which, typically comprises a laser, a photo detector, a TIA and optical fibers).

For improved performance, the following guidelines should be followed:
1. Use short on-die routing between the ingress and egress circuits of the Hybrid-PHY Chip 604.
2. For efficient layout utilization, build the DSP circuitry around the Serializer/Deserializer (SerDes) circuits.
3. To decrease routing distances for the critically important Rx to Tx paths, cluster the SerDes circuits close to one another.

FIG. 7 is a block diagram that schematically illustrates the physical layout of an optical communication system 700, in accordance with an embodiment that is disclosed herein. A Host-ASIC 702 sends and receives electrical information, through a Hybrid-PHY Chip 704, that is converted to light signals, which are sent to/received from an Optical Subsystem. The Hybrid-PHY chip 704 comprises a Host-side Receive circuit (HRX) 706 that processes an input signal that the Host-ASIC 702 sends, and outputs the processed signal to a Line-Side Transmit (LTX) circuit 708. The LTX circuit 708 sends a corresponding drive signal to a Laser 712, which sends a light signal to the optical subsystem.

In the receive side, a photo-detector 714 converts light to an electrical signal, which is amplified by a TIA 716. In the Hybrid-PHY chip 704, a Line-Side Receive Circuit (LRX) 718 processes the signal that the TIA 716 sends and sends a processed signal to a Host-Side Transmit Circuit (HTX), which sends an output according to the received light signal to the Host ASIC 702.

In addition to the guidelines presented above, with reference to FIG. 6, pinout locations on all four sides of the chip package may be optimized to minimize the physical distance between the Laser Driver 710 and LTX 708, and between TIA 716 and LRX 718.

In some embodiments, some or all of Laser Driver 710 and TIA 716 is integrated in the Hybrid-PHY chip 704. In other embodiments, Silicon Photonics techniques may be used, to integrate some or all the optics into the Hybrid-PHY chip.

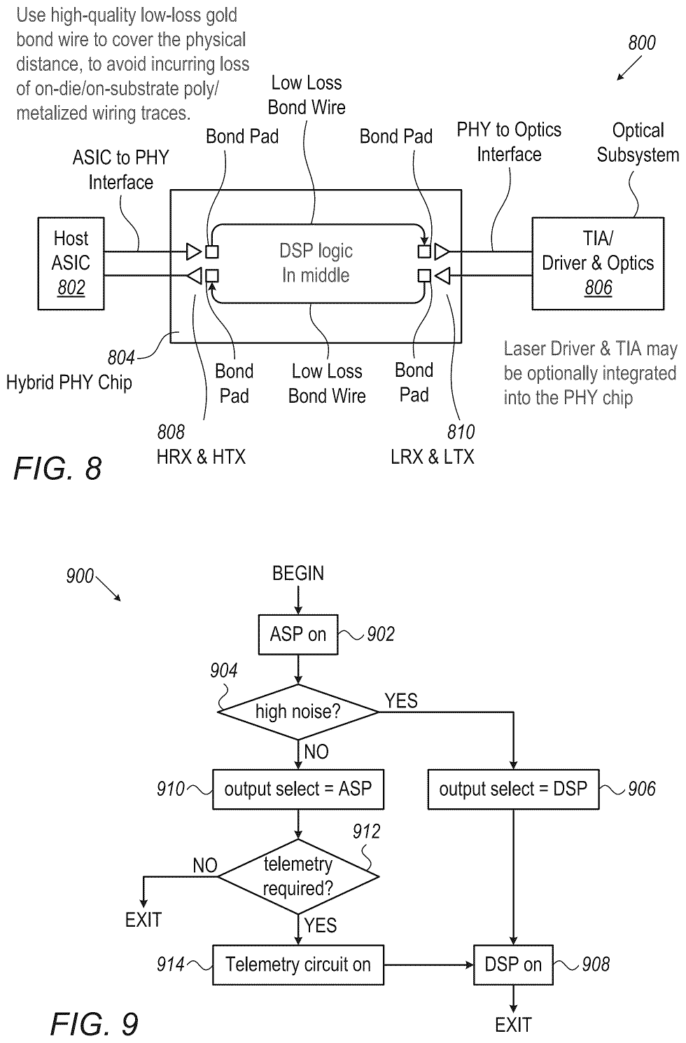

FIG. 8 is a block diagram that schematically illustrates the physical layout of an Optical Communication System 800, in accordance with an embodiment that is disclosed herein. Optical Communication System 800 comprises a Host ASIC 802, a Hybrid PHY Chip 804 and a TIA-Driver&Optics circuit 806. The Hybrid PHY Chip 804 comprises host-side HRX-HTX receivers/transmitters 808, and line-side LRX-LTX receivers/transmitters 810.

According to the example embodiment illustrated in FIG. 8, the DSP circuitry of both the Ingress (optics to host) and Egress (host to optics) paths are physically located at the center of the Hybrid PHY Chip 804. For low analog-mode latency, however, it is not desirable to route signals from the Host-Side to the Optics-side of the Chip through metal and poly conductors, due to the relatively long on-die delays of poly and/or metal traces. Instead, in some embodiments, High-quality low-loss gold bond wires are used to cover the physical distance, for improved signal quality.

FIG. 9 is a flowchart 900 that schematically illustrates a method for a Hybrid transceiver configuration, in accordance with an embodiment that is disclosed herein. It is assumed that each PHY transceiver (Ingress or Egress) comprises an ASP, a DSP, a Telemetry Circuit (for communicating telemetry data gathered by the DSP to the host) and a Mode-Select switch, to select the ASP or the DSP outputs.

In embodiments, the flowchart may be executed by a user, who prepares configuration data for a processor that configured the PHY transceivers.

The configuration data may include, for example, the following switches (separately for each transceiver):
1. ASP circuit: on or off
2. DSP circuit: on or off
3. Output-select switch: ASP or DSP
4. Telemetry circuit: on or off.

Note that, in this example embodiment, Mixed Mode is the combination where the Output-Select switch is set to select the ASP, but both the ASP and the DSP circuits are activated.

The processor typically configures the transceivers according to the configuration data pursuant to a Reset and/or a Boot operation. In some embodiments, full or partial configuration or reconfiguration may be initiated if a run-time signal quality measure changes (e.g., a transceiver may be reconfigured from analog to DSP mode if a Bit Error Rate (BER) measure falls below a preset threshold). The user executes flowchart 900 separately for every transceiver to be configured.

The method starts at a SET-ASP-On operation 902, wherein the user sets the ASP circuit on. Next, at a Check-High-Noise operation 904, the user checks whether the channel coupled to the transceiver is a high-noise channel, in which digital signal processing must be done to accurately decode the received signal. If so, the user enters a Set-Output-Select-DSP operation 906, set the Output-Select switch to DSP, and then enters a Set-DSP Circuit-On operation 908, to set the DSP circuit on.

If, in operation 904, channel noise is low enough so that DSP is not required, the user enters a Set-Output-Select-ASP operation 910, sets the Output-Select switch to ASP, and then enters a Check-Telemetry-Required operation 912. If telemetry is not required, the flowchart ends. If, in operation 912, telemetry is needed, the user enters a Set-Telemetry Circuit-On operation 914, to set the Telemetry circuit on, and then enters the Set-DSP Circuit-On operation 908, to set the DSP circuit on. After operation 908 the flowchart ends.

Thus, according to the example flowchart illustrated in FIG. 9 and described above, a user can set the configuration data of any or all the transceivers of a PHY device, according to channel noise conditions and to telemetry requirements, by selectively enabling the ASP, DSP and telemetry circuits of the transceiver, and by configuring the output select of the transceivers to select the ASP or the DSP.

The configuration of flowchart 900 illustrated in FIG. 9 and described hereinabove is cited by way of example. Other configurations may be used in alternative embodiments. For example, in an embodiment, a low-latency requirement may override the signal quality check and the output select may be set to ASP even when the signal quality is low. In some embodiments, a predefined set of the DSP functional is needed for telemetry and, when telemetry is required, only parts of the DSP circuit will be enabled.

The configurations of the network device PHY circuits illustrated in FIG. 1 through 8 and described hereinabove are cited by way of example. Other configurations may be used in alternative embodiments. For example, in some embodiments, in Hybrid PHY Device 300 (FIG. 3), the Host ASIC receives digital data, (e.g., through a high-speed parallel bus) and, hence, DAC 346 is not needed, PGA 348 is replaced by an ADC, and analog multiplexor 350 is a digital multiplexor. In another embodiment, the Host ASIC sends digital data to Hybrid PHY Device 300, and the HRX-LTX path changes accordingly.

In some embodiments, telemetry of the Host line is not needed, and hence, Telemetry circuit 516 (FIG. 5) is configured to send telemetry information pertaining to the Line only. In other embodiments, in Hybrid PHY 500 (FIG. 5), low latency in one of the directions is not important, and hence, one or both of Egress Transceiver 502 and Ingress Transceiver 506 may be set to the DSP mode.

The various elements of the disclosed PHY devices and network devices may be implemented using dedicated hardware or firmware, such as using hard-wired or programmable logic, e.g., in one or more Application-Specific Integrated Circuits (ASIC) or Field-Programmable Gate Arrays (FPGA). Additionally, or alternatively, certain elements of the disclosed PHY devices and network devices may be implemented in software and/or using a combination of hardware and software elements. Elements that are not mandatory for understanding of the disclosed techniques have been omitted from the figure for the sake of clarity.

In some embodiments, certain functions of the disclosed PHY devices and network devices, e.g., controller 118 and/or controller 206, may be implemented in one or more programmable processors, e.g., one or more Central Processing Units (CPUs) or microcontrollers, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Although the embodiments described herein mainly address optical transceivers, the methods and systems described herein can also be used in electrical-only transceivers, such as a Line Card PHY chip that is printed on a PC Board, or a PHY chip embedded within an

### Active Electrical Cable.

It is noted that the embodiments described above are cited by way of example, and that the present invention is not limited to what has been particularly shown and described hereinabove. Rather, the scope of the present invention includes both combinations and sub-combinations of the various s described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A Physical Layer (PHY) device, comprising:
an ingress transceiver and an egress transceiver, each comprising respective analog signal processing (ASP) circuitry and respective digital signal processing (DSP) circuitry; and
a controller, configured to select an operational mode, for one or both of the ingress transceiver and the egress transceiver, between (i) a digital mode in which both the ASP circuitry and the DSP circuitry are active, and (ii) an analog mode in which the ASP circuitry is active and the DSP circuitry is bypassed.

2. The PHY device according to claim 1, wherein the controller is configured to select the operational mode independently for the ingress transceiver and for the egress transceiver.

3. The PHY device according to claim 1, wherein the ASP circuitry comprises analog repeater circuitry configured to amplify an analog signal.

4. The PHY device according to claim 1, wherein the DSP circuitry comprises digital retiming circuitry configured to digitally adjust a sampling timing of a digital signal.

5. The PHY device according to claim 1, wherein the DSP circuitry has a first latency, and wherein the ASP circuitry has a second latency smaller than the first latency.

6. The PHY device according to claim 1, wherein, when either or both of the ingress transceiver and the egress transceiver operate in the analog mode, the DSP circuitry is bypassed but active and is configured when bypassed to collect telemetry information.

7. The PHY device according to claim 1, wherein:
the ingress transceiver and the egress transceiver are configured to, respectively, receive and transmit signals over a communication link; and
the controller is configured to select the operational mode by comparing channel conditions of the communication link to a defined level.

8. A network device, comprising:
multiple Physical Layer (PHY) devices configured to communicate over respective network links, the PHY devices comprising ingress transceivers and egress transceivers, each of the ingress transceivers and egress transceivers comprising respective analog signal processing (ASP) circuitry and respective digital signal processing (DSP) circuitry; and
a controller, configured to select an operational mode for one or both of the ingress transceivers and the egress transceivers of each PHY device, the operational mode selected between (i) a digital mode in which both the ASP circuitry and the DSP circuitry are active, and (ii) an analog mode in which the ASP circuitry is active and the DSP circuitry is bypassed.

9. The network device according to claim 8, wherein the controller is configured to select the operational mode for first and second PHY devices independently of one another.

10. The network device according to claim 8, wherein, for a given PHY device among the multiple PHY devices, the controller is configured to select the operational mode independently for the ingress transceiver and for the egress transceiver of the given PHY device.

11. The network device according to claim 8, wherein the ASP circuitry comprises analog repeater circuitry configured to amplify an analog signal.

12. The network device according to claim 8, wherein the DSP circuitry comprises digital retiming circuitry configured to digitally adjust a sampling timing of a digital signal.

13. The network device according to claim 8, wherein the DSP circuitry has a first latency, and wherein the ASP circuitry has a second latency smaller than the first latency.

14. The network device according to claim 8, wherein, in a given PHY device among the multiple PHY devices, when either or both of the ingress transceiver and the egress transceiver operate in the analog mode, the DSP circuitry is bypassed but active and is configured when bypassed to collect telemetry information.

15. The network device according to claim 8, wherein, for a given PHY device among the multiple PHY devices:
the ingress transceiver and the egress transceiver are configured to, respectively, receive and transmit signals over a communication link; and
the controller is configured to select the operational mode by comparing channel conditions of the communication link to a defined level.

16. A method in a Physical Layer (PHY) device that includes an ingress transceiver and an egress transceiver, each including respective analog signal processing (ASP) circuitry and respective digital signal processing (DSP) circuitry, the method comprising:
selecting an operational mode, for one or both of the ingress transceiver and the egress transceiver, between (i) a digital mode in which both the ASP circuitry and the DSP circuitry are active, and (ii) an analog mode in which the ASP circuitry is active and the DSP circuitry is bypassed; and
communicating over a communication link in accordance with the selected operational mode.

17. The method according to claim 16, wherein selecting the operational mode is performed independently for the ingress transceiver and for the egress transceiver.

18. The method according to claim 16, wherein the DSP circuitry has a first latency, and wherein the ASP circuitry has a second latency smaller than the first latency.

19. The method according to claim 16, further comprising, when either or both of the ingress transceiver and the egress transceiver operate in the analog mode and the DSP circuitry is bypassed, collecting telemetry information using the bypassed DSP circuitry.

20. The method according to claim 16, wherein selecting an operational mode comprises comparing channel conditions of the communication link to a defined level.
